(19) United States
(12) Patent Application Publication
(10) Pub. No.: US 2020/0080397 A1
(43) Pub. Date: Mar. 12, 2020

(54) VALVE ASSEMBLY

(71) Applicant: Daliburgh Subsea Ltd., Isle of South Uist (GB)

(72) Inventor: Neil Walker, Aberdeen (GB)

(21) Appl. No.: 16/467,283

(22) PCT Filed: Dec. 5, 2017
(86) PCT No.: PCT/GB2017/053669

§ 371 Date: Jun. 6, 2019

(30) Foreign Application Priority Data
Dec. 6, 2016 (GB) 1620731.8

(51) Int. Cl. E21B 34/10; F16K 5/06

(52) U.S. Cl. CPC E21B 34/10; E21B 33/0355; F16K 5/0652

(57) ABSTRACT

A valve assembly for an oil, gas or water well, the valve assembly comprising a conduit having a bore; a valve closure member movable on a rotational path around a pivot axis to open and close the bore; a drive member movable on a linear path; and a drive train transmitting force between the drive member and the valve closure member; wherein the drive train comprises a plurality of bearing devices (e.g. ball bearings) constrained in a bearing track. Moving the drive member rotates the valve closure member (e.g. a ball valve) between open and closed configurations to open and close a fluid flowpath in the well. The actuating assembly can be actuated between different configurations using differential fluid pressure, optionally transmitted in an annulus of the well.

The present invention relates to a valve assembly, particularly for use on an oil or gas well. In some cases the valve is a downhole valve configured for controlling fluid flow in a wellbore of a well, although other examples are used on topsides valves or on subsea valves at the wellhead or on a pipeline.

WO2014/193405 discloses a ball valve assembly which is useful for understanding the invention.

### SUMMARY

The invention provides a valve assembly for an oil, gas or water well, the valve assembly comprising:

a conduit having a bore;

a valve closure member movable on a rotational path around a pivot axis to open and close the bore;

a drive member movable on a linear path;

a drive train transmitting force between the drive member and the valve closure member;

wherein the drive train comprises a plurality of bearing devices constrained in a bearing track.

Optionally the drive member can comprise a piston.

Optionally driving movement of one of the valve closure member and the drive member drives movement of the other along its respective path. Optionally the drive member is driven in order to rotate the valve closure member (but the reverse is also possible). Optionally the driving movement of one of the drive member and valve closure members drives one towards the other. Optionally driving movement of one of the piston and valve closure members compresses the drive train. Optionally the driving movement of one of the piston and valve closure member pushes the other along its path. Optionally the drive member and the valve closure member are biased resiliently towards the drive train, compressing the drive train between them. Optionally the drive train engages at one end with the drive member and at the other end with the valve closure member. Optionally the linear movement of the piston along its linear path rotates the valve closure member along its rotational path.

Optionally the bearing devices are ball bearings. Cylindrical bearings or bearings with other shapes could also be used.

Optionally the valve assembly is a subsea valve assembly of an oil, gas or water well, and in one example, the actuator assembly comprises a ball valve, rotating to open and close a bore of the well. Optionally the bore comprises a fluid conduit, providing a flowpath for fluid through the valve assembly. Optionally the bore can accommodate strings of tools or wireline deployed into the well.

Optionally the valve closure member comprises a shoulder member, optionally movable in an arc, optionally along the rotational path of the valve closure member. Optionally the shoulder member moves pivotally around the pivot axis of the valve closure member. Optionally the shoulder member has a shoulder engaged by a bearing device in the drive train to transmit force between the bearing device and the shoulder. Optionally the shoulder member is connected to the valve closure member such as e.g. a ball in a ball valve, so that rotation of the shoulder member rotates the ball between open and closed configurations. Optionally multiple shoulders are provided, optionally one for each direction of rotation, each shoulder being adapted to be rotated by a respective drive train and piston device, or alternatively, the shoulder member may have more than one face, engaged by different bearing devices to push the shoulder member in opposite directions along the rotational path. Optionally the bearing track abuts the valve closure member. Optionally the bearing devices are movable along the bearing track. Optionally the bearing devices can comprise a low friction material, e.g. Silicon Nitride. Other bearing materials can be used.

Optionally the surface of the valve closure member on which the bearing device engages is flat. Optionally the flat surface is formed by cutting away a portion of a wall of the valve closure member.

Optionally first and second piston devices are provided, each acting on a common valve closure member, i.e. acting on a common shoulder member. Optionally the first and second piston devices drive (e.g. push) the valve closure member in opposite rotational directions. In one example, optionally the first and second piston devices respectively open and close the valve, for example, rotating a ball between open and closed configurations, where a fluid pathway through the ball allows fluid passage through the ball in an open configuration, and resists fluid passage through the ball when closed.

The invention also provides an oil, gas or water well ball valve for opening or closing a bore in a fluid pathway, having

drive member movable on a linear path;

a valve closure member movable on a rotational path around a pivot axis;

a drive train transmitting force between the drive member and the valve closure member;

wherein the drive train comprises a plurality of bearing devices constrained in a bearing track.

The invention also provides an actuator assembly for actuating a mechanism of an oil, gas or water well, the actuator comprising:

a drive member movable on a linear path;

a rotary member movable on a rotational path around a pivot axis;

a drive train transmitting force between the drive member and the valve closure member;

wherein the drive train comprises a plurality of bearing devices constrained in a bearing track.

In another aspect, the invention provides a method of actuating a mechanism in an oil, gas or water well, the mechanism comprising

a drive member movable on a linear path;

a valve closure member movable on a rotational path around a pivot axis;

a drive train transmitting force between the drive member and the valve closure member;

wherein the drive train comprises a plurality of bearing devices constrained in a bearing track;

wherein the method comprises moving one of the piston and the valve closure member to drive movement of the other along its path.

Optionally the mechanism is a valve, optionally a ball valve, having a valve closure member that rotates to open and close a fluid conduit.

Optionally the assembly has a clutch mechanism (e.g., a rotating sleeve, J-slot, or optionally an endless J-slot) which actuates the drive member to move along its linear path, and optionally has an indexing function. Optionally the clutch mechanism comprises a rotating sleeve which moves axially and rotationally under the control of a pin captive in a slot. Optionally the clutch mechanism engages the drive member via a crenelated profile on the sleeve comprising a sequence of platforms extending axially from the ends of the sleeves, and optionally disposed circumferentially between adjacent slots. Optionally the crenelated profile drives movement of the drive member along its linear path when the crenelated profile presents a platform to the drive member and does not drive the drive member (or drives it to a lesser extent) when the drive member is engaged in a slot on the crenelated profile. The slots and platforms can optionally have regular circumferential spacing, but this is not necessary, and in some cases, irregular spacing is useful for at least one of the slots and platforms.

Optionally the actuating assembly is actuated using fluid pressure, e.g., a fluid pressure differential transmitted in the bore of the valve, or in an annulus between the outer surface of the valve assembly and the inner surface of the bore of the well, which can optionally be cased or lined. The assembly optionally includes at least two chambers adapted for retaining pressurised fluid (e.g. a gas) and for actuating the assembly in response to a pressure differential. A first chamber is optionally pre-charged to a minimum threshold pressure for activating the assembly, optionally at a higher pressure than the second chamber, which is optionally pre-charged with pressurised fluid to a nominal baseline pressure, for example, atmospheric pressure. The valve assembly is optionally shifted between configurations by exposure to pressure. The stroking mechanism comprising the first and second chambers and associated pistons cycling the valve assembly are optionally below the valve, optionally on the outside of the housing unconnected with the bore of the valve and optionally exposed to the well annulus between the inner surface of the well and the outer surface of the housing of the valve assembly.

In some examples, the actuating assembly can be electronically actuated and controlled.

The assembly optionally has a housing. Optionally the housing houses the drive train separately from the fluid conduit of the valve, which is advantageous as the fluid in the bore does not convey debris to the drive train components, which are therefore relatively insensitive to debris. Optionally the drive member and drive train are disposed in a side wall of the housing, optionally parallel to a fluid pathway in a bore of the housing. Optionally where two drive members are provided, each with a respective drive train, the drive members are in alignment with their respective drive trains. Optionally in that example, the drive members are arranged side by side and circumferentially spaced apart in the housing. Optionally the drive trains are at least partially arranged side by side in the housing and circumferentially spaced apart. Optionally the housing is tubular.

In one example used in a downhole valve, the actuating assembly can operate a full bore ball valve from either ‘open to closed’ or ‘closed to open’, and can cycle between the two configurations repeatedly. The actuating assembly is optionally accommodated within a relatively thin wall section which ensures as large an inner diameter as possible though the valve whilst maintaining a standard outside diameter to suit standard casing sizes in the well. This has the benefit that the valve can be controlled by application of differential pressure i.e. annulus pressure applied from surface, once the subsea tubing hanger is installed and production packer is set. This reduces the need for intervention in the well to close or open the valve, or provide additional well hydraulic control functions, and removes concerns about barrier tool battery life.

Pressure differentials can be used to cycle the assembly between different configurations, and optionally through a sequence of configurations leading to opening and closing of the valve, without other transmission of power or signals by other methods into the well. Optionally the valve assembly can cycle repeatedly between different configurations.

Load is optionally applied to end of one of the drive member (optionally by a resilient device such as a spring or by a hydraulic pressure differential) which compresses the bearing devices between the rotational member and the drive member. Cycling the clutch through a sequence (for example a sequence of stops at circumferential intervals) can apply a load to another drive member to move the rotational member back to the initial configuration. The clutch optionally removes load from one piston when applying it to the other.

In certain aspects, major components of the assembly that operate to either open or close are in compression rather than in shear or in tension. For example, the drive train optionally bears directly onto the shoulder member of the valve closure member and pushes the valve closure member closed while remaining in compression between the valve closure member and the drive member.

Optionally components can be made from or faced with a suitable hard and compression resistant material (e.g., tungsten carbide). The piston rod, ball bearings and rotational drive may be manufactured from or faced with hard materials optionally including tungsten carbide, or Silicon Nitride or other materials to increase the hardness and compressive strength of the mechanism. The drive member and drive train and optionally an external face of the valve closure member are optionally disposed outside the central bore of the fluid pathway which allows enhanced debris tolerance.

Optionally the assembly comprises a secondary contingency shifting mechanism (optionally above the valve closure member) to change the configuration of the valve if the primary opening mechanism fails. Optionally the valve closure member and the secondary shifting mechanism are held within an ordinarily locked sleeve. The sleeve may be locked in place by, for example, shear pins, a snap ring, a collet, or similar devices. Optionally the sleeve can be unlocked, optionally to move in an axial direction. Optionally axial travel of the sleeve actuates the valve closure member.

Optionally, the secondary shifting mechanism comprises a fishing neck, optionally within the wall of the uphole end of the assembly. Optionally a fishing tool can be deployed downhole into the bore of the assembly to engage the fishing neck. Optionally once the fishing tool has hooked onto the fishing neck, the fishing tool may be pulled upon from the surface, which in turn pulls the sleeve housing the valve closure member and the secondary shifting mechanism and overcomes the locking device. The sleeve can thus move a limited axial distance, sufficient to actuate the valve closure member. For example, the axial movement of the sleeve may actuate the drive train and pivot the valve closure member around the pivot axis. Alternatively, the secondary shifting mechanism may have a rod or similar attachment that engages in a recess formed in the wall of the valve closure member.

Optionally the valve assembly comprises a locking mechanism to lock the valve assembly in a position, for example, in a running in position, and resist its actuation until the locking mechanism is released. Optionally the locking mechanism can comprise shear elements such as shear pins adapted to shear at threshold forces, and the locking mechanism can be released by setting down or pulling up on the string, or by mechanical action. Optionally the shear pin locks a piston movable in a housing under fluid pressure. Optionally the locking mechanism comprises an electronic lock. Optionally the locking mechanism comprises a collet.

The valve assembly is optionally run into the well and is deployed in a sealed section of the well (for example allowing pressurization of the wellbore around the valve assembly). In one example, the valve assembly is run in via tubing as part of the upper completion string (optionally just below the subsea tubing hanger). Once the subsea tubing hanger is landed and set in the wellhead, the ball valve optionally remains open due to both the pre-charged atmospheric chamber pressure and an interlock restricting actuation of the valve until released. Locking the initial running in position using the interlock or shear elements, collets or other locking devices allows downhole circulating, setting and testing of other tools in the completion to be performed without the worry of prematurely closing the ball valve.

When setting and testing the production packer the interlock is released and permits the actuation (e.g. closing) of the ball valve. As the annulus pressure is cycled following packer setting the valve optionally rotates to a closed position after a predefined number of pressure cycles. Pressure may then be applied to the tubing to test the ball valve from above before disconnecting the BOP and recovery leaving the well secure with the closed ball valve as a second barrier element.

There can optionally be a predetermined number of annulus pressure cycles required to move the ball from closed to open position which therefore ensures the valve remains in the closed position. If the ball valve fails to close with the application of annulus pressure a standard well intervention can be performed as contingency, to set a wireline plug in the tubing hanger nipple profile, using a mechanical setting mechanism.

Optionally, once the subsea christmas tree is installed onto the wellhead the annulus is opened, for example, using a tubing hanger sliding sleeve to increase annulus pressure in the sealed annulus surrounding the valve assembly between the tubing hanger and a production packer. While maintaining the annulus pressure the tubing pressure can be slowly increased until the pressure is balanced across the ball, which facilitates opening. The ball valve is optionally designed to be opened under a pressure differential. Once communication is achieved the annulus pressure may be cycled to function the ball valve from closed to open position. The final open position of the ball valve can be locked by independent spring loaded keys which optionally prevent any further movement of the actuating device (optionally the atmospheric chamber) once the ball is open. If the ball does not open then a secondary contingency shifting profile above the ball can be actuated mechanically to move the ball from the closed to the open position.

In certain examples, the valve assembly provides a tubing-conveyed barrier plug ideal for deep water subsea well applications to reduce rig time. Full bypass area (e.g. 4.700″ id) through ball valve can be provided when running the completion into well. The ball valve is optionally closed and opened remotely with the application of annulus pressure, which is ideal for a tubing hanger barrier valve application following setting of the production packer and prior to disconnecting the BOP. In certain examples, ball closure will not necessarily initiate until after production packer is set. Optionally the locking mechanism prevents premature actuation. In certain examples, the valve assembly provides a robust debris tolerant, non-translating ball valve with smooth internal ID profile minimizing areas for debris to collect. Operation at higher pressures can lead to better sealing. However, the ball can be resiliently energized against a seat to promote sealing at low pressures.

In certain examples, the valve assembly reduces the requirement for additional signals or power from surface to control the valve i.e. avoiding or reducing hydraulic feedthroughs required through a workover system or tubing hanger/tree. In certain examples, there is a reduced requirement for well intervention to function the ball valve open-closed-open. Multiple cycles (8, 12 or 16 positions) allow different configurations of the actuator in response to pressure changes without moving the ball which can remain in the closed position even with fluctuations of annulus pressure. Hence, other systems in the well can be functioned or pressure tested without actuating the ball. Further, the configuration of the valve closure member can be determined by the configuration of the clutch or indexing mechanism, which can adopt different configurations of the clutch having the same configuration of valve closure member, so the annulus pressure can be therefore cycled to move the actuator assembly of the clutch without necessarily affecting the configuration of the valve closure member. Further, the clutch mechanism can be biased by e.g. the first pressurized chamber, to drive the clutch mechanism against the drive means in the absence of pressure in the annulus, which is useful, as it is not necessary to maintain a pressure differential in the annulus to maintain the open or closed configuration of the valve.

An optional shear pin can lock the ball in an initial configuration e.g. to ensure the valve stays closed until the application of pump pressure above a trigger threshold to the annulus. In certain examples, the valve can be operated without reliance on electronics avoiding battery issues. Thus the valve can remain in closed position indefinitely without concerns about battery life. Certain examples minimise potential leak paths between tubing and annulus. Optionally spring loaded pins could be used to lock the valve in the closed position. The pins are not engaged in mating hole until the components rotate and line up the pins with the flat bottom holes in mandrel. The pins can optionally comprise shear pins.

Certain examples allow a simple compact design with minimal component parts when compared to alternative products on market, and a shorter tool length of approximately 3 m. Certain examples allow a contingency operation if the valve does not move, for example, a nipple profile above the ball to set a conventional wireline plug i.e. tubing hanger nipple profile. Optionally there is also a contingency if the ball does not re-open, optionally providing a mechanical shifting mechanism above the ball. Optional nipple and seal bores across the ball valve provide a secondary sealing sleeve option. Certain examples eliminate the need to intervene into the well either before recovery of the BOP or following the installation of the christmas tree. This can save drilling rig or light well intervention vessel days while improving safety during the completion operation as there is a reduced requirement to rig up and perform slick line. In certain examples, the valve assembly can simplify the method of installing the tree onto the well as there is a reduced requirement to rig up and perform well intervention, so a simpler vessel can be used to install the tree. In certain examples, the assembly may be easily/readily converted from single shot open-closed-open cycle to alternative multiple cycling applications. While actuation by atmospheric pistons is an option, the assembly allows different actuation options, for example, via hydraulic, electric or resilient mechanisms. Further, the ball valve can readily be bypassed with downhole electrical/hydraulic lines.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the scope of the present invention as defined in the claims. Accordingly, each example herein should be understood to have broad application, and is meant to illustrate one possible way of carrying out the invention, without intending to suggest that the scope of this disclosure, including the claims, is limited to that example. Furthermore, the terminology and phraseology used herein is solely used for descriptive purposes and should not be construed as limiting in scope. In particular, unless otherwise stated, dimensions and numerical values included herein are presented as examples illustrating one possible aspect of the claimed subject matter, without limiting the disclosure to the particular dimensions or values recited. All numerical values in this disclosure are understood as being modified by “about”. All singular forms of elements, or any other components described herein are understood to include plural forms thereof and vice versa.

Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee. In particular, positional references in relation to the well such as “up” and similar terms will be interpreted to refer to a direction toward the point of entry of the borehole into the ground or the seabed, and “down” and similar terms will be interpreted to refer to a direction away from the point of entry, whether the well being referred to is a conventional vertical well or a deviated well.

### BRIEF DESCRIPTION OF THE DRAWINGS

In the accompanying drawings:

FIGS. 1 a-e show plan, sectional, detailed section of a ball valve, and perspective views of a valve assembly for an oil, gas or water well when running into a hole;

FIGS. 2 a-c show views similar to FIG. 1 of the valve assembly with an interlock released;

FIGS. 3 a and b show views similar to FIG. 1 a and b of the valve assembly with an actuator piston moving down while the valve remains open;

FIGS. 4 a-d show views similar to FIG. 1 of the valve assembly with the actuator piston moving upwards in a further cycle in which the upward movement actuates the drive train and shifts the valve from open to closed;

FIGS. 5 a-d show views similar to FIG. 1 of the valve assembly with the actuator piston moving down in a further cycle while the valve remains closed;

FIGS. 6 a-e show views similar to FIG. 1 a-e of the valve assembly with the actuator piston moving upwards in a further cycle in which the upward movement actuates the drive train and shifts the valve from closed to open;

FIG. 7 shows a perspective view of the valve assembly in the FIG. 1 configuration;

FIG. 8 shows a perspective view of the valve assembly in the FIG. 4 configuration; and

FIG. 9 shows a perspective view of the valve assembly in the FIG. 6 configuration.

### DETAILED DESCRIPTION OF EXAMPLES OF THE INVENTION

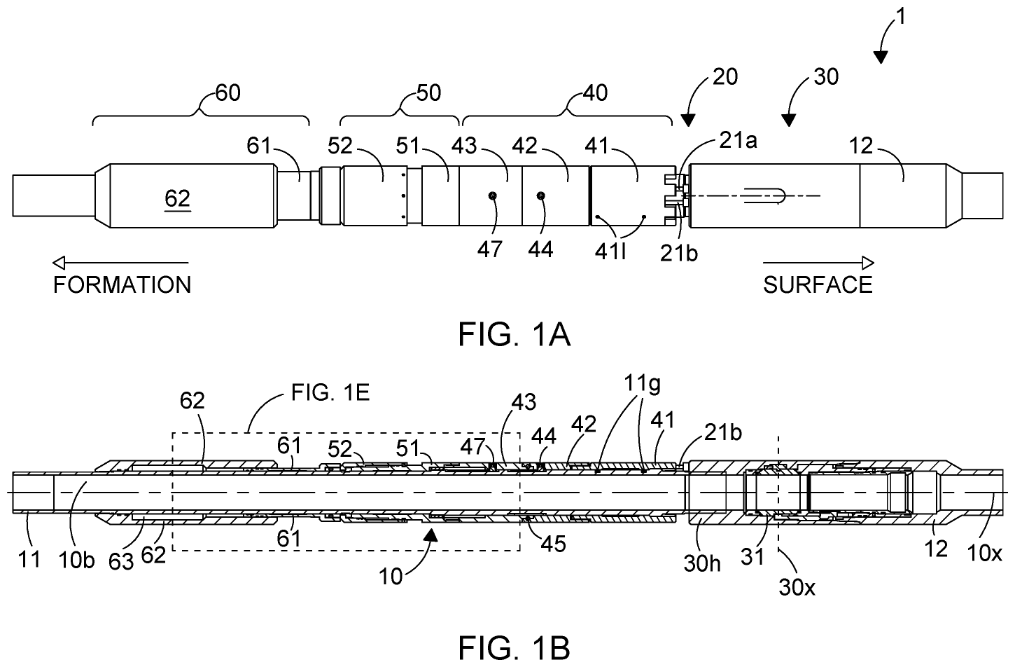

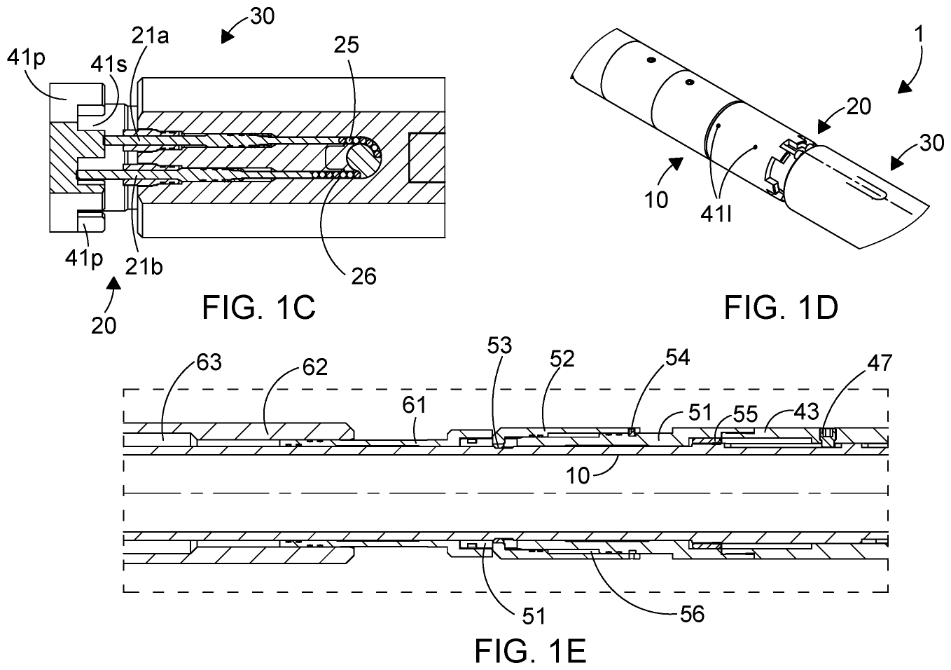

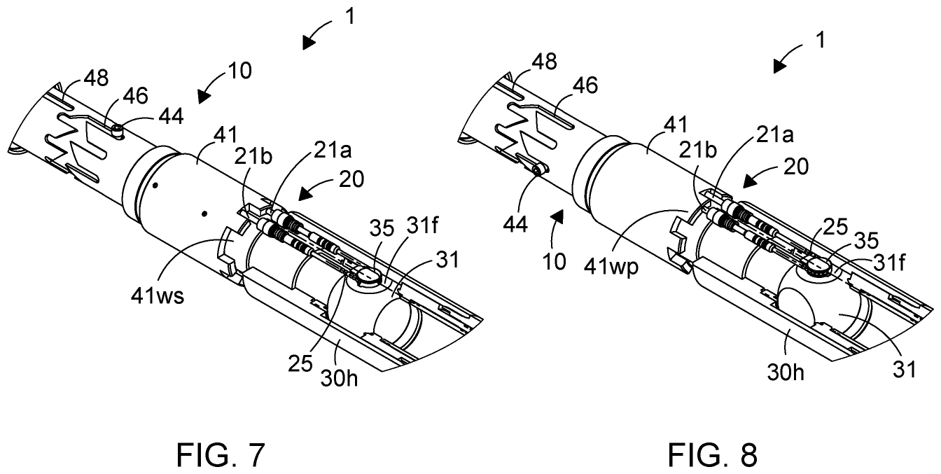

Referring now to the drawings, a valve assembly 1 has a body 10 with a bore 10b, the body 10 comprising an upper sub 12 connected to a lower mandrel 11. The top sub 12 is attached by screw threads to a ball valve housing 30h, which houses a valve closure member in the form of ball valve 30, having a ball 31 movable on a rotational path around a pivot axis 30x to open and close the bore 10b. The ball 31 is partially spherical, having flats 31f on opposing sides (best seen in FIGS. 7-9) and having a central flow path extending through the ball 31, which can rotate in and out of register with the central bore 10b around a ball axis 30x to open and close the bore 10b. The flats 31f on the opposing sides are disposed on either side of the central flow path through the ball 31 and the axis 30x of the ball passes through the flats. The internal diameter of the bore through the ball 31 is substantially the same as the internal diameter of the bore 10b at its maximum, as can be seen in FIG. 1, so the ball 31 does not reduce the available internal diameter of the valve assembly when open. The bore 10b in this example comprises a fluid conduit, providing a flowpath for fluid through the valve assembly 1, which in this case is opened and closed by the rotation of the ball 31.

The lower end of the valve housing 30h has an internally threaded bore which receives the upper end of the mandrel 11, which has a co-operating external thread. The mandrel 11 is connected to the valve housing 30h at the beginning of the assembly procedure. All the components are assembled onto the mandrel from the bottom end. The ball 31 is supported on the pivot axis 30x within the housing 30h which perpendicularly traverses the central axis 10x of the bore 10b, so that the ball 31 can pivot around the ball axis 30x within the bore 10b.

The valve assembly 1 also has a drive member in the form of pistons 21a, 21b, movable on a linear path and housed in side-by-side cylinders in the wall of the housing (as best seen in FIG. 7-9), and a drive train 20 transmitting force between the pistons 21 and the ball 31, in order to drive rotation of the ball 31 via the linear movement of the pistons 21. The drive train 20 comprises a plurality of bearing devices 25 constrained in a bearing track 26, which can optionally comprise a tubular recess within the housing 30h forming a bore that receives the upper ends of the pistons 21 and the bearings 25, and which defines the path on which the bearings move between the pistons 21 and the ball 31.

FIGS. 1a-1e and FIG. 7 show the valve assembly 1 in a configuration suitable for running into a well. The ball 31 is in an open configuration for run-in. From left to right as shown in the drawings (in which the “lower” end of the assembly 1 which is deeper in the hole and closer to the formation is on the left hand side, and the “upper” end of the assembly which is closer to the surface is on the right) the valve assembly 1 comprises a number of inter-connected sleeve components comprising an actuator 60, an interlock assembly 50, and a clutch 40, axially spaced from the ball valve 30, each surrounding the mandrel 11 and connecting together to move axially as a single sleeve along the exterior surface of the body 10. Optionally a further sleeve or housing can be placed over the valve assembly 1 to protect the components from, for example, debris ingress.

The actuator 60 has a housing 62 fixed via a screw-thread to the outer surface of the mandrel 11, with an annular pressure chamber 63 formed in the annulus between the housing 62 and the mandrel 11, and which is sealed to the mandrel 11 at the lower end. The chamber is in fluid communication through its upper end with a narrower circumferential annular recess housing and sealing a lower portion of an actuator piston 61, forming a sleeve around the mandrel 11 and movable axially within the circumferential annular recess up and down the body 10. The chamber 63 and the recess are pre-charged with pressurised fluid, for example nitrogen, at surface before the assembly is run downhole. The pressure of the fluid can be at several thousand psi, for example 1000-3000 psi (approximately 7-21 MPa). In one example, the pressure may be closer to 2000 psi (approximately 14 MPa). The pressure in the chamber 63 is above ambient pressure in the well, and so acts on the sealed portion of the actuator piston 61 retained within the circumferential recess between the interior of the actuator housing 62 and the exterior surface of the mandrel 11, normally urging the actuator piston 61 upwards relative to the chamber 62 in the absence of other forces acting on the actuator piston 61. Hence, at ambient pressure in the well (e.g. in the annulus) and at the surface, the actuating piston 62 is normally extended out of the recess by the pressure within the chamber.

The interlock assembly 50 immediately above the actuating piston 61 has an interlock piston housing 52 and an interlock piston 51 and optionally acts to lock the sleeve formed by the actuator piston 61 and the clutch 40 onto the body in a fixed position on the body 10 for running into the hole, and optionally to release the sleeves once actuation of the valve assembly commences. In this example, the interlock piston 51 is partially contained within the interlock piston housing 52. The actuator piston 61 has bayonet-type protrusions on its interior surface that are circumferentially spaced, which align with grooves in the interlock piston 51 so that while initially separate, once assembled, the interlock piston 51 and actuator piston 61 are locked together by a bayonet-style fitting so they move axially as one piece along the body 10. The interlock housing 52 is keyed to the interlock piston 51 by a shear pin 54 that passes through the interlock housing 52 and into the interlock piston 51, holding both components 51, 52, stationary relative to each other when running into a hole. The interlock housing 52 and interlock piston 51 define a sealed pressurised interlock chamber 56 between them. The pressurised interlock chamber 56 is pre-charged at the surface with fluid, for example a compressible fluid like a gas such as nitrogen, but is normally pressurised to a lower value than the chamber 63; for example, 1 atm (˜101 kPa) may be sufficient. The pressurising of the interlock chamber 56 can prevent premature release of the interlock. The details of the interlock can be changed in various different examples.

When running into the hole, the actuator piston 61 and interlock piston 51 are keyed into the mandrel 11 by a snap ring 53, held in a groove on the outer surface of the mandrel 11 to maintain the axial positions of the various components of the interlock assembly 50, the clutch 40 and the actuator piston 61 relative to the mandrel 11 when running into the hole.

In the example shown in FIG. 1, the clutch 40 has two pin sleeves 43, 42 disposed above the interlock assembly 50. Sleeve 43 is connected to the upper end of the interlock piston by a screw thread. Sleeve 43 houses an anti-rotation pin 47 keyed into an axial slot in the mandrel 11, so that the sleeve 43 is constrained to only move axially along the mandrel 11 and does not rotate relative to the mandrel 11. Sleeve 42 is connected to sleeve 43 by a bearing race 45 and can rotate relative to sleeve 43 and the other sleeves above it but still moves axially with the sleeve 43. Sleeve 42 houses a J-pin 44 in engagement with a J-slot, and axial movement of the sleeves 43, 42 drives movement of J-pin 44 in the J-slot, rotating sleeve 42 around the body 10 relative to the non-rotating sleeve 43 and the mandrel 11. At the upper end of the clutch 40, facing the ball valve housing 30h, there is a clutch ring 41 which is fixedly attached at a first (lower) end to the rotating sleeve 42, for example by grub screws or by a screw thread, and therefore rotates with rotating sleeve 42 around the mandrel 11 under the control of the J-slot arrangement between the rotating sleeve 42 and the mandrel 11, relative to the upper sleeves 43, 50, 61.

The second (upper) end of the clutch ring 41 facing the ball valve housing 30h is crenelated, with platforms 41p and slots 41s. The platforms 41p and slots 41s can all be of equal dimensions, or alternatively some may be wider than others. In this example, for example FIG. 1d, it can be seen that there is at least one wider slot 41ws and at least one wider platform 41wp. The crenelations engage with the pistons 21 forming part of the drive train 20. As the clutch ring 41 rotates, the platforms and slots may be presented in different configurations to the pistons 21 as will be described in more detail below.

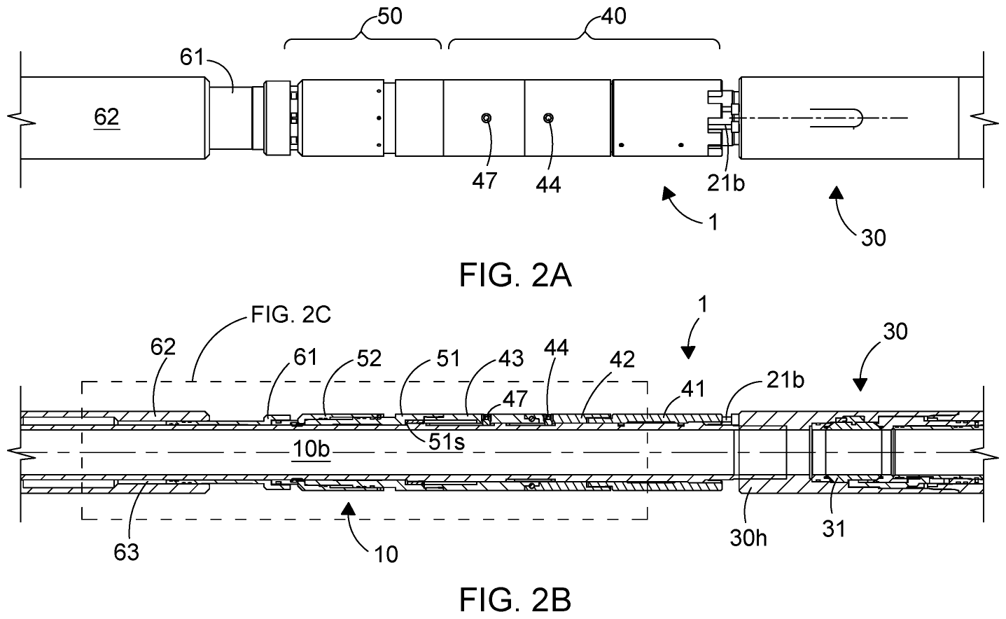

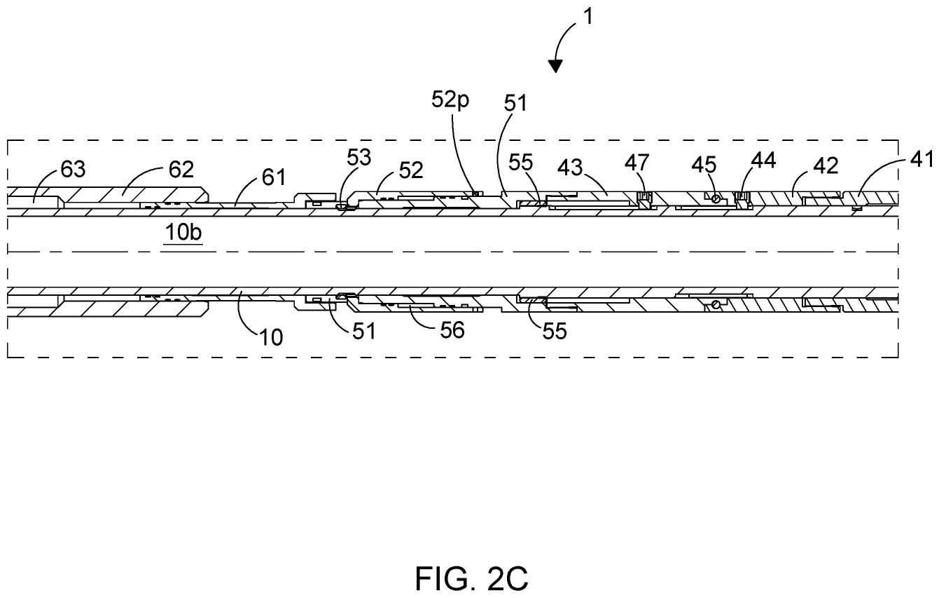

FIGS. 2a-2c show the valve assembly 1 after having been run in to the well, and with the interlock uncoupled, so that the assembly is ready for actuation. Notice that the components of the clutch 40, namely the fixed and rotating sleeves 43, 42 are in the same relative positions as in FIG. 1 when the assembly 1 is run into the hole, the upper end of the clutch ring 41 is still engaged with the pistons 21, the bayonet connection between the interlock piston 51 and the actuator piston 61 is still engaged, and the only change is in the position of components of the interlock assembly 50 (the interlock housing 52 has moved up slightly to expose the snap ring 53).

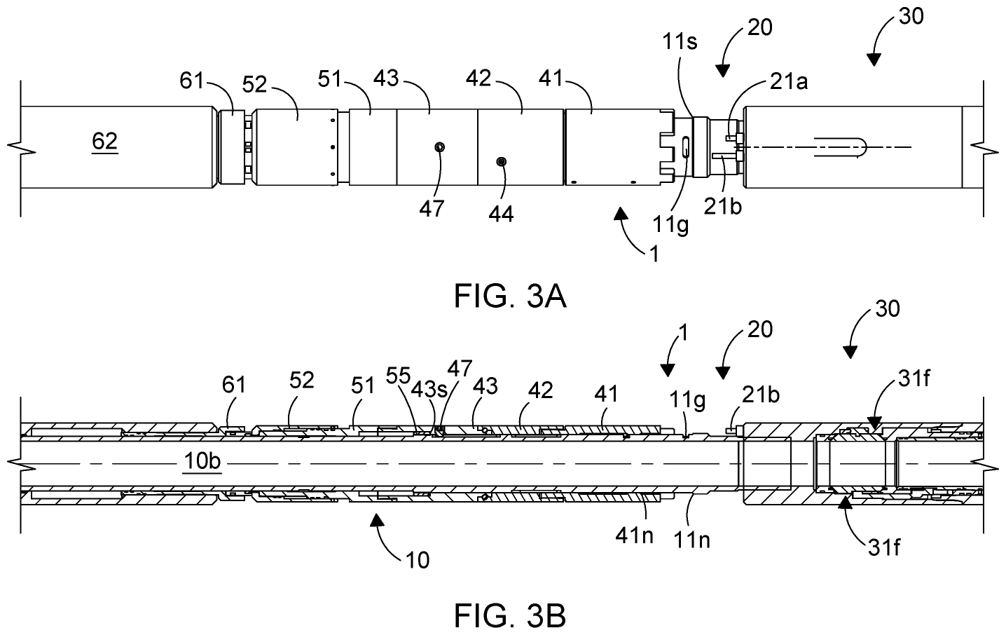

Prior to reaching the FIG. 2 configuration, the valve assembly 1 in this example is run into the well below the tubing hanger and above a production packer, and is disposed in the annulus between the production tubing and the casing or other outer wall of the well. Before the assembly can be used in this position, the interlock assembly 50 needs to be uncoupled to allow movement of the actuator piston 61, the interlock assembly 50 and the clutch 40 axially along the body 10. To do this, once the valve assembly 1 is in place between the tubing hanger and the production packer, the production packer will be set and tested from annulus above to a pressure that will release the interlock assembly thus starting the closure of the ball valve. For example, the wellbore annulus housing the valve assembly 1 is pressured up from surface through the well's annulus port to several thousand psi, for example 3000-6000 psi (˜21-41 MPa) or to another pressure higher than the pressure in the chamber 63. The high annular pressure outside the assembly 1 applies a pressure differential to the interlock housing 52, which is urged upwards relative to the interlock piston 51 by the pressure differential across the interlock housing 52 because the annulus pressure is much higher than the atmospheric pressure trapped in the chamber 56, consequently applying a shear force to the shear pin 54 connecting the piston 61 to the interlock housing 52. At a threshold annulus pressure, the shear pin 54 shears and the fluid in the chamber 56 collapses as the interlock piston housing 52 moves up the mandrel 11 relative to the interlock piston 51 to the FIG. 2 position. FIG. 2c shows the interlock piston housing 52 having moved upwards over the interlock piston 51. As it moves up the body 10 relative to the actuator piston 61 and interlock sleeve 51, the interlock housing 52 uncovers the snap ring 53 and releases it to spring radially outwards from the groove in the mandrel 11. Release of the snap ring 53 from the groove in the mandrel 11 frees the inter-connected assembly of the interlock piston 51 and the actuator piston 61 to move axially downwards along the exterior surface of the mandrel 11 as a unit, urged in that direction by the pressure differential acting on the actuation piston 61. The annular pressure is higher than the pressure in the chamber 63, so the actuation piston 61 and attached interlock piston 51 together move down under the pressure differential across the piston 61 as the lower end of the piston 61 slides down into the circumferential recess 63 to the FIG. 3 position. The axial travel of the interlock assembly 50 and the clutch 40 is limited in the downhole direction by a stop ring 55 fixed to the outer surface of the mandrel 11 which abuts a downwardly facing inner shoulder 43s on the axial pin sleeve 43 at the greatest extent of downhole travel (see FIG. 3). The uphole movement of the sleeves 61, 50, 40 is limited by an external annular no-go shoulder 11n on the outer surface of the mandrel (best seen in FIG. 3) which abuts an internal annular no-go shoulder 41n on the inner surface of the clutch ring 41 and prevents the clutch ring from further upward axial movement from the FIG. 2 position. The interlock piston 51 and the actuator piston 61 remain inter-engaged with each other, and sections 40, 50, and actuator piston 61 move axially together as a unit to actuate the ball valve 30. This limitation of upward movement protects the pistons 21 from excessive axial force applied by the force acting on the actuating piston 61, and protects the j-pins from being over-loaded at the end of the J-slot.

In response to changes in the pressure differential between the chamber 62 and the annulus outside the bore 10b, the clutch 40, interlock assembly 50, and actuator piston 61 thus move together axially relative to the mandrel 11 of the valve assembly 1. Pressure differentials can be applied from the surface via a conventional annulus port in the well to cycle the assembly 1 between different configurations, and optionally through a sequence of configurations leading to opening and closing of the ball valve 30, without other transmission of power or signals by other methods into the well. In some examples, the valve can be cycled through different configurations by resilient devices such as springs or electrical actuators etc., and actuation by pressure differentials is not essential. Optionally when the pressure in the annulus is below the pressure in the chamber 62, the piston 61 extends and drives the clutch 40 into contact with the components of the ball valve 30, which maintains the configuration of the ball valve 30 even when the annulus bore is de-pressurised. Since the configuration of the ball valve 30 depends on the configuration of the clutch 40 in different rotational positions, the annulus pressure can be cycled several times (depending on the configuration of the clutch/ball valve interface) without necessarily changing the configuration of the ball valve 30.

FIGS. 3a and 3b show the sleeve components 61, 50, 40 of the valve assembly 1 after moving downwards along the body 10 towards the actuator end of the valve assembly under the force of the pressure differential acting on the actuator piston 61. Actuator piston 61 slides deeper into the circumferential recess connected to the actuator housing 62 in response to the pressure differentials applied by the high annulus pressure. Anti-rotation pin 47 tracks along the axial slot and maintains the rotational alignment of the axial pin sleeve 43, the interlock assembly 50, and the actuator 60 with respect to the mandrel 11. Rotation of the actuator piston 61 relative to the mandrel 11 is undesirable in this example due to the interlocking engagement of the circumferentially discontinuous bayonet protrusions connecting the actuator piston 61 to the interlock piston 51.

Axial downward movement of the clutch 40 causes the J-pin 44 to track in the J-slot and rotates the rotating sleeve 42 in accordance with the geometry of the J-slot, which also rotates the clutch ring 41 fixedly attached to the lower end of the rotating sleeve 42 via a screw thread. As the sleeve components 61, 50, 40 have moved down towards the actuator end of the valve assembly, the clutch ring 41 is retracted away from the drive train 20 and pistons 21 during rotation. Notice the different relative positions of the J-pin 44 in FIGS. 2 and 3, illustrating the rotation of the clutch ring 41 and J-pin housing relative to the axial pin sleeve 43. The assembly can retain this position for as long as the annular pressure is applied to overcome the pressure in the chamber 63. Thus pressure signals to control the configuration of the valve assembly can be transmitted in the annulus of the well, without taking bore pressure into consideration, allowing more flexibility of operation in certain examples of the valve assembly.

Venting or other reduction in the annular pressure triggers movement from the FIG. 3 position.

Starting from the FIG. 3 position, as annular pressure falls below the pressure in the chamber 63, the actuating piston 61 is driven upwards by the expansion of the gas in the chamber 63. The upper sleeve components 61, 50 and 43 remain circumferentially fixed by the J-pin 47 in the axial slot as before, and the clutch ring 41 rotates anticlockwise again under the control of the J-slot and the J-pin 44 on the rotating sleeve 42 as the sleeve components 61, 50, 40 together move axially upwards towards the valve housing 30h and the pistons 21. One single axial translation of the clutch ring 41 in this example up or down through the J-slot rotates the clutch ring 41 in an anticlockwise direction 45′ from the previous position. In this example, the circumferential spacing between adjacent axial portions of the J-slot is regular, but in other examples, this can be varied if desired. Two pistons are provided in this example, 21a and 21b, which together act to drive the movement of the ball valve 30 in different rotational directions, although it would be possible to provide a modified example with a single piston 21 adapted to drive the ball valve in a single direction. Pistons 21a and 21b are arranged within cylinders disposed side by side at the same axial position on the ball valve housing 30h with a circumferential spacing between them so that the pistons 21a, 21b align axially with different circumferentially spaced parts of the crenelated end of the clutch ring 41. The cylinders are sealed within the body outside the bore 10b. For a given configuration of the valve assembly 1, prior to axial movement of the clutch ring 41 towards the actuator, a platform 41p of the clutch ring 41 may be in engagement with, for example, piston 21a. At the same time, piston 21b may be within a slot 41s, as best seen in FIG. 1c, so that the pistons 21a, b are in opposite configurations.

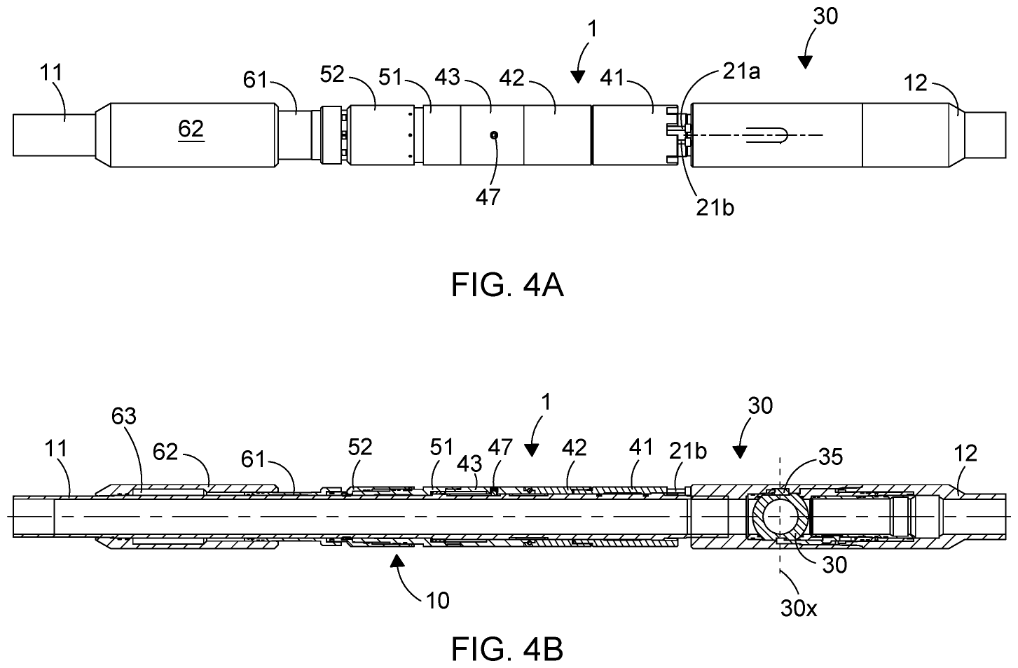

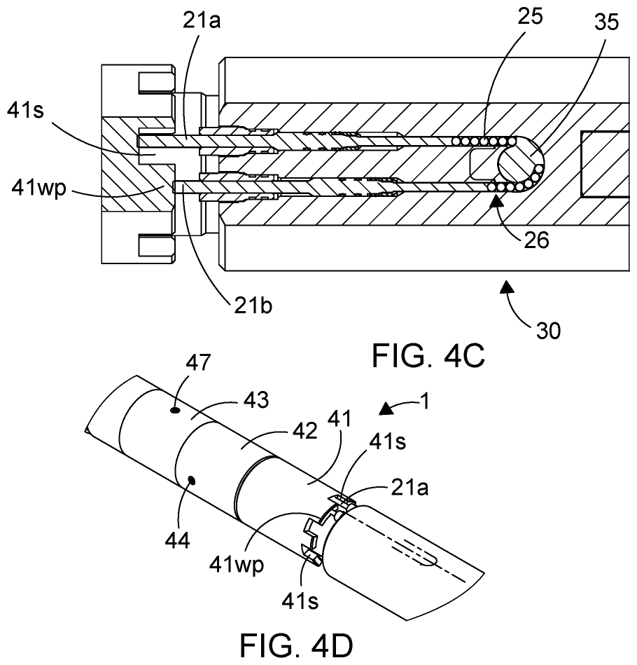

The sleeves in the interlock 50 and clutch 40 retract along the mandrel 11 under the influence of annular pressure changes, and return to their original axial position, with the clutch ring 41 having rotated 45° as described above. In this example, several axial cycles of the clutch 40 may take place before any change in the configuration of the drive train 20 is initiated, that is, the clutch ring 41 may translate axially up and down the body 10 several times and upon returning each time, may again present a platform 41p (e.g. a different platform 41p) to piston 21a, and may again present a slot 41s to piston 21b. In this event, the configuration of the ball valve 30 does not change, as the pistons 21 do not encounter any change in the geometry of the clutch ring 41 and so do not move in response. In this example, several cycles of axial movement of the sleeves 61, 50, 40 with corresponding rotation of the clutch ring 41 have occurred between the FIG. 3 and FIG. 4 positions, as can be seen by comparing the relative positions of the J-pin 44 in FIGS. 4 and 2. This is useful, as it allows an operator to run through a sequence of pressure changes (to pressure test the well and/or activate other tools in the well etc.) before finally triggering a functional change in the valve assembly 1. This also reduces the risk of an inadvertent triggering of a functional change by a one-off kick in the pressure profile of the well, and allows pressure checking regimes to be part of the triggering sequence. The number and effects of pressure changes in the triggering sequence can be changed simply by modifying the number of lateral deviations in the J-slot, or the arrangement of platforms and slots on the end of the clutch ring 41.

Notice that for brevity in the drawings, not all of the different positions of the valve assembly in the sequence are shown in the drawings, as some of them are substantially identical to those shown in FIGS. 2 and 3, except that the rotating sleeve 42 has moved around the body 10 with the clutch ring 41, and the pistons 21 engage different but similarly shaped slots and protrusions in the intermediate positions. As the same shapes are presented to the pistons 21 or the ball 31, there is no difference in the effect of these intermediate positions, and the pistons 21 remain in the position shown in FIGS. 1-3 throughout the different intermediate positions of the clutch. As described above, the number of intermediate positions can be varied in different examples.

In the final cycle of axial translation of the clutch 40 before a configuration change in the pistons 21, when the clutch ring 41 approaches the ball valve housing 30h when moving into the FIG. 4 position, the crenelated end of the clutch ring presents a different profile of protrusions and slots to the pistons 21 to change their configuration, and this rotates the ball 31 in the valve 30 as will be described below. In this example, the crenelated end of the clutch ring 41 has an irregular profile on its upper end, which eventually rotates around the body 10 to engage the pistons 21 in a different configuration, but in some examples, instead of a differential in the crenelated pattern of the clutch ring 41, the differential can be provided in the J-slot, which can move the clutch ring 41 in different rotational intervals if desired.

FIGS. 4a-4d and FIG. 8 show the actuation of the ball 31 to the closed configuration. The clutch ring 41 has rotated and, in this example, presented a wider platform 41wp to the piston 21b. Piston 21b has been pushed upwards into the ball valve housing 30h by the wider platform 41wp and has driven the movement of the bearings 25 around the bearing track 26. In this example, the bearings 25 are ball bearings, but they can be cylindrical or another shape in other examples. Piston 21a is not aligned with a slot and has been pushed downwards as a result of the movement of the bearings 25 and now sits within a slot 41s adjacent to the wider platform 41wp. The pistons 21 are optionally resiliently biased towards the ball 31 and this compresses the drive train 20 between the two pistons 21; this resilient bias may be in the form of a load applied to one end of the pistons 21 by, for example, a resilient spring, or a hydraulic pressure differential.

The bearings 25 engage at one end with a respective piston 21a, 21b, and at the other end with a shoulder member which in this example is in the form of a paddle 35 connected to the ball 31. In this case, the two bearing trains from the pistons 21a, 21b engages with separate shoulders on opposite sides of the paddle 35, and act on the shoulders to rotate the paddle 35 in opposite directions. For example, linear movement of a first piston, for example, compression of piston 21b along its linear path axially towards the ball 31 pushes the ball bearings 25 acting on a shoulder on one side of the paddle 35 to drive rotation of the paddle 35 anticlockwise around the pivot axis 30x of the ball 31. The anticlockwise rotation of the paddle 35 pushes the bearing train engaging the shoulder on the other side of the paddle 35 to extend the other piston 21a away from the ball in the opposite linear direction from piston 21b. To rotate the paddle 35 in the opposite direction, piston 21a is compressed towards the ball 31, and piston 21b is extended away from it. The paddle 35 is directly connected to the ball 31, and so rotation of the shoulders on the paddle 35 rotates the ball 31 along its rotational path.

The paddle 35 is fixed to the ball 31 on one of the flats 31f located on the sides of the ball on opposite sides of the bore through the ball 31 (see FIGS. 7-9). The paddle 35 extends radially in line with the pivot axis 30x from the flat 31f and moves pivotally with the ball 31 in the same rotational path around the pivot axis 30x of the ball valve 30. The paddle 35 is engaged by the bearings 25 in the drive train 20, and rotation of the paddle 35 rotates the ball 31 between open and closed configurations.

The flat 31f is formed in this example by milling or cutting away a portion of a wall of the ball 31. The thickness of the wall of the ball 31 is selected to be thick enough to resist the high forces the cut-away portion(s) will be exposed to, while maintaining as large an internal diameter as possible when the ball valve 30 is in the open configuration.

The paddle 35 in the present example has a generally cylindrical central column with extends perpendicular to the axis 10x of the bore from the flat 31f along the axis 30x; and a spur extending from the central column in a radial direction with respect to the axis 30x, away from the pistons 21. The spur has two outer shoulders provided by respective side walls on opposite sides of the spur extending in planes that are parallel to the axis 30x. The planes of the shoulders are not parallel to one another, and diverge from the central column at approximately 45° with respect to one another, as best seen in FIG. 1c. The precise angle between the planes of the shoulders is not important. The shoulders extend radially with respect to the axis 30x from the central column of the paddle 35, and provide shoulders on opposing sides of the paddle 35 for the bearings 25 to press against in order to transmit force from the pistons 21 to the ball 31. The bearings 25 are constrained in the race 26 formed in the housing 30h which winds in an arc around part of the cylindrical central column of the paddle 35, so that the central column forms part of the bearing track retaining the bearings. The paddle 35 has a planar cap covering the central column and enclosing the bearings 25 which engage the shoulders of the spur underneath the cap. The cap assists with retaining the bearings 25 within the bearing track as they move. The cap can have a thin profile in order to keep the extent of radial protrusion of the paddle 35 in the direction of the axis 30x to a minimum.

As a first piston, for example 21b, is pushed upwards towards the ball valve 30 (as shown in FIGS. 4a-4d), the bearings 25 are in turn pushed around the arc of the bearing track 26 against the spur, which drives the rotation of the spur and central column in an anticlockwise direction. This pushes the opposite shoulder on the other side of the spur against the bearings between the opposite shoulder and the second piston 21a, causing the second piston 21a to move downwards towards the clutch ring 41 under the force applied by the first piston 21b. Since the piston 21a is aligned with a slot 41s and is not prevented from extending, it extends downwards into the slot 41s under the force of the first piston 21b. As the bearings 25 drive the rotation of the paddle 35 connected to the ball 31 at the flat 31f, they drive rotational movement of the ball 31 in the same anticlockwise direction. The movement of the pistons 21 and the engagement of the bearings 25 with the paddle 35 therefore actuate the ball 31 between open and closed configurations.

Pressure cycling from 1,500 psi-3,000 psi is sufficient to cycle the assembly to close the ball valve. Differential pressure of 1,000 psi in this example will generate a sufficient load to move the piston drive rod into the ball housing. When the ball is closed and the actuating piston 61 is cycled to final position the annulus pressure may optionally be maintained while then applying tubing pressure above the ball 31 to reduce any differential across the ball 31 to zero which can help to open the valve 30. The final position can optionally provide multiple seals (metal, dual peek and dual elastomer backup are all options) on the piston rods.

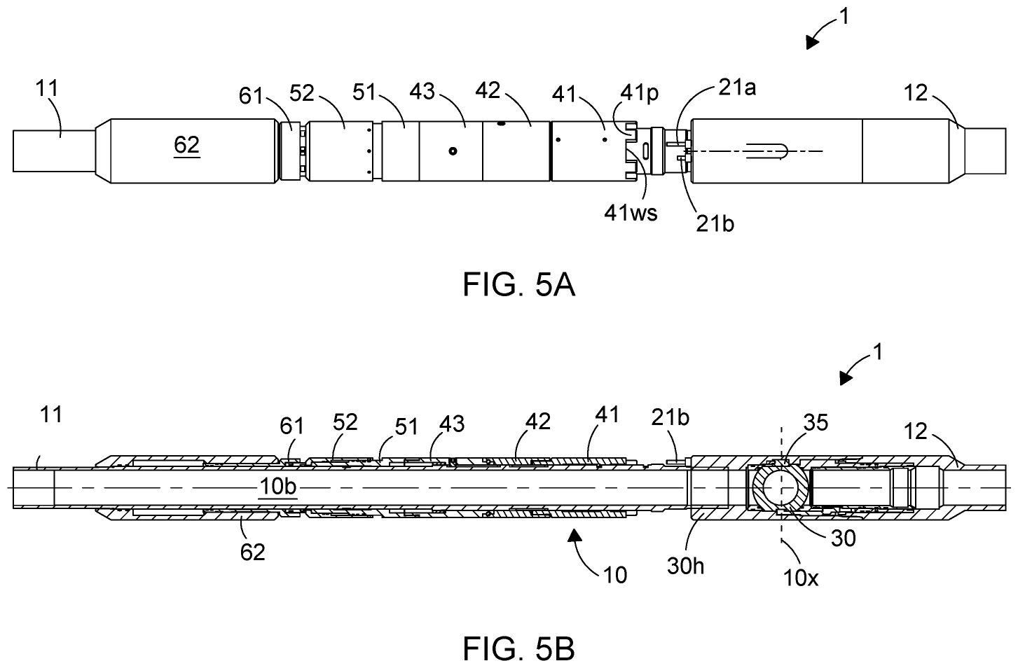

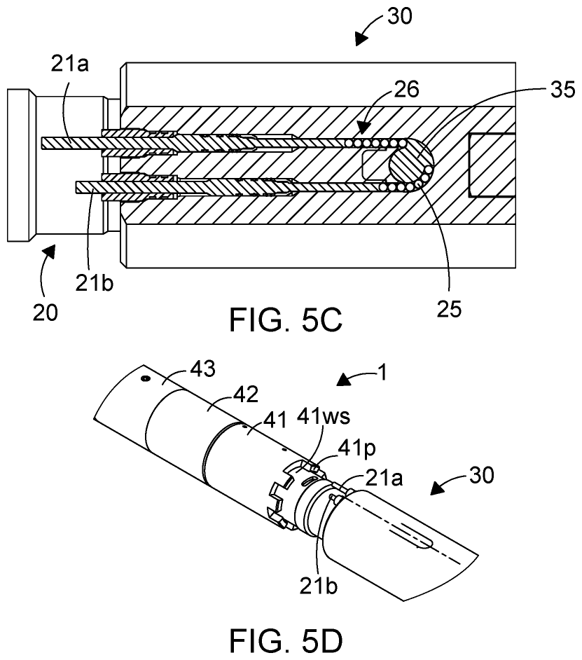

FIGS. 5a-5d show a later cycle of the valve assembly 1, the actuator piston 61, interlock assembly 50, and clutch 40 having moved again into a retracted configuration where the clutch 40 is axially spaced away from the piston 21. The ball 31 remains in the closed configuration during the rotation as the intervening positions between those shown in FIGS. 4 and 5 have not changed the configuration of the pistons 21, as the same pattern of platforms and slots have been presented to the pistons 21 on each cycle of the assembly. Since the pistons 21 have not moved from the FIG. 4 position, the ball 31 has not rotated. However, notice that the rotating sleeve 42 has moved around the body 10 in the various intermediate positions, and is now approaching the starting position of FIG. 2. Notice that once again for brevity, some of the intermediate positions of the valve assembly in the sequence leading up to FIG. 5 are not shown in the drawings, as some of them are identical to those shown in FIGS. 3 and 4, except that the rotating sleeve 42 has moved around the body 10 with the clutch ring 41, and the pistons 21 have engaged different but similarly shaped slots and protrusions in the intermediate positions.

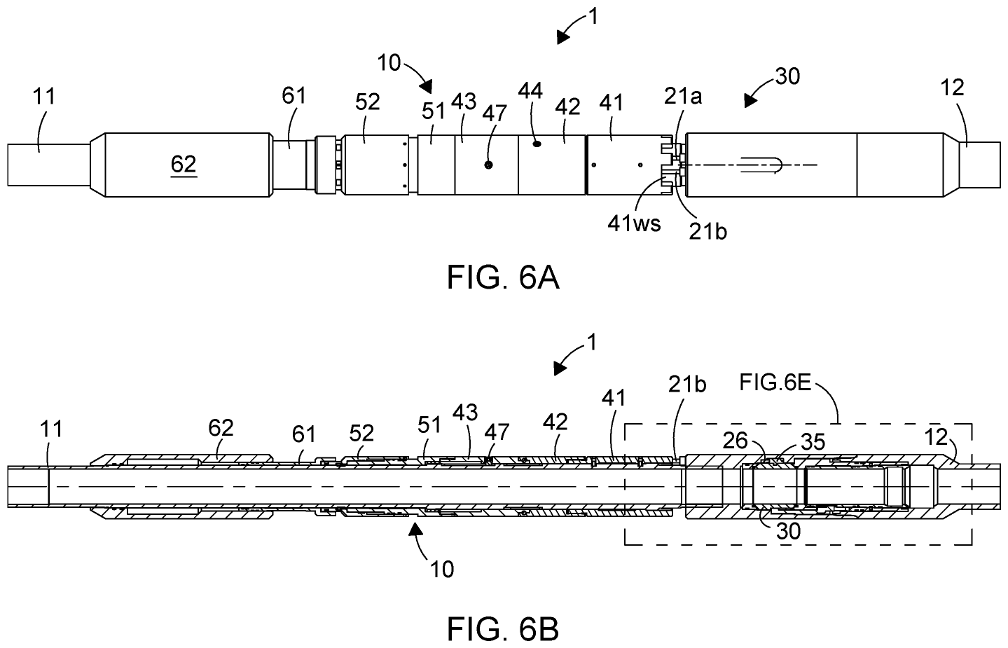

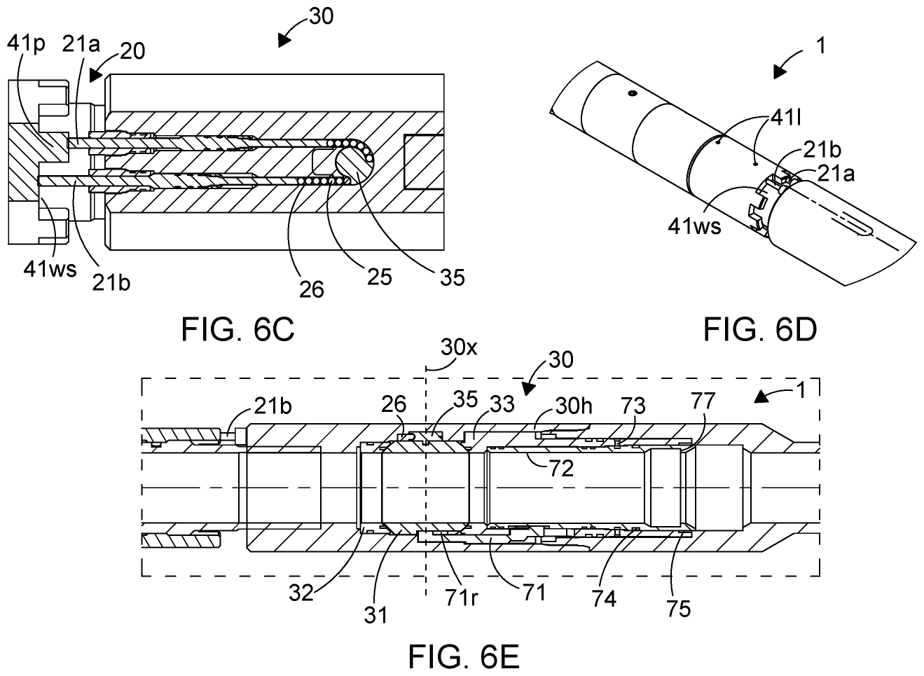

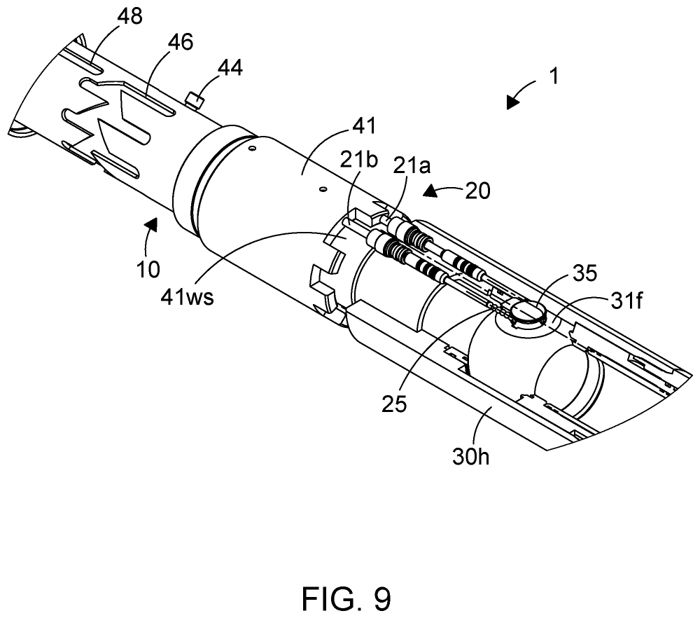

FIGS. 6a-6e and FIG. 9 show the return travel of the actuator piston 61, interlock assembly 50, and clutch 40 following from the configuration shown in FIGS. 5a-5d into the last position in which the ball is rotated to the open position. There is a wider slot 41ws, best seen in FIG. 6c, which has changed the configuration of the crenelations to present a platform 41p to piston 21a and a slot 41s to piston 21b. The load previously applied to piston 21b is transferred to piston 21a, which is pushed axially by the platform 41p towards the ball 31, driving the bearings 25 in the opposite direction to FIGS. 4a-4d. Piston 21b moves towards the clutch ring 41, driven by the bearings 25 moving around the track 26, and extends into the wide slot 41ws. Movement of the bearings 25 around the paddle 35 rotates the ball 31 back into the open configuration as previously described.

When reaching the FIG. 6 position, the clutch ring 41 is optionally locked in position in this example. This is achieved by two locking pins (providing a primary and a backup lock) 41l resiliently biased in compression between the inner surface of the clutch ring 41 and the outer surface of the mandrel 11. The outer surface of the mandrel 11 has a pair of stop grooves 11g (one is visible in FIG. 3) extending circumferentially perpendicular to the axis 10x of the bore for a short distance around the outer surface, but initially being circumferentially out of register with the locking pins 41l. When the assembly is in the FIG. 1 position, with the shoulder 11s abutting against the shoulder 41n, and the sleeves 61, 50, 40 at their uppermost limit of axial movement, the locking pins 41l are circumferentially spaced around the body 10, but at the same axial position, just to the anticlockwise side of the grooves 11g. Anticlockwise movement of the pins 41l with the clutch 41 moves the pins 41l around the body away from the groove 11g, and they maintain their resilient bias between the inner surface of the clutch ring 41 and the outer surface of the mandrel 11 until just before the FIG. 6 position, in which the clutch ring 41 has moved around 315° around the body, and the pins 41l approach the start of the grooves 11g. As the clutch ring 41 moves round, the pins 41l reach the grooves 11g and extend resiliently into the grooves 11g, in which they can track for a further short distance, but further rotation of the clutch ring 41 around the body 10 is limited by the circumferential dimensions of the grooves 11g, which the pins 41l cannot escape once they are extended. Hence, the assembly locks in the FIG. 6 open position in this example, with the ball 31 open and must be recovered to the surface before being reset. Note that the J-slot 46 engaged by the J-pin 44 in this example is linear (rather than endless) and the FIG. 6 position coincides with the pin 44 tracking down the final axial track of the J-slot 46.

The valve assembly 1 optionally has a secondary contingency shifting mechanism above the ball 31, to change the configuration of the ball 31 if the primary opening mechanism fails. The ball 31 is mounted on pivot axis 30x between lower and upper ball seats 32, 33 fixed within the housing 30h as is best shown in FIG. 6e. Optionally, the ball 31 is urged against one of the seats 32, 33 by resilient device such as a disc or wave spring optionally disposed between the ball 31 and one of the seats 32, 33, which will apply a pre-load between the ball and the other of the seats 32, 33 to enhance low pressure sealing. Each side of the ball 31 has a flat plateau section, on one side bearing the paddle 35, driving rotation of the ball 31 in normal operation, and on the opposite side, bearing a J-shaped cam recess 71r engaging a pin on a lower end of a release rod 71 extending from and connected to a release sleeve 72. The release sleeve 72 is ordinarily locked in place in the upper ball seat 33 by shear pin 73, which when sheared unlocks the release sleeve 72 to move in an axial direction with respect to the upper ball seat 33, pulling the release rod 71 upwards a tracking it through the J-shaped recess 71r on the flat face of the ball 31, causing the ball 31 to rotate around its pivot axis 30x. The release sleeve 72 can be unlocked to move axially upwards in the bore (to the right hand side of the drawings) by shearing the pin 73. Optionally the ball seats are fixed and cannot move axially. In this example, the secondary shifting mechanism includes a fishing neck 77 formed at the uphole end of the release sleeve 72. A fishing tool (not shown) can be deployed downhole into the bore of the assembly 1 to engage the fishing neck 77, which can then be pulled axially upwards under a force applied from the surface to shear the pin 73 and axially move the release sleeve 72 to rotate the ball 31 either from the open configuration to the closed configuration, or vice versa.

FIGS. 7-9 show partial cutaway views of the ball valve 30, the clutch ring 41, and the J-pin 44 in J-slot 46. The axial slot 48 contained within sleeve 43 can be partially seen. FIG. 7 shows the ball 31 in the first open configuration, as shown in FIGS. 2a-2c, with the J-pin 44 at the beginning of J-slot 46. FIG. 8 shows the clutch ring 41 having undergone 2 cycles of rotation, equal to 90°, to actuate the ball 31 to the closed configuration as shown in FIGS. 4a-4d. FIG. 9 shows the J-pin 44 at the end of the J-slot 46, having actuated the ball 31 back into its open configuration as shown in FIG. 6.

1. A valve assembly for a selected one of (a) an oil well, (b) a gas well, or (c) a water well, the valve assembly comprising:
a conduit having a bore;
a valve closure member movable on a rotational path around a pivot axis so as to open and close the bore;
a drive member movable on a linear path;
a drive train transmitting force between the drive member and the valve closure member;
wherein the drive train includes a plurality of bearing devices, wherein each bearing device is constrained in a bearing track.

2. (canceled)

3. The valve assembly of claim 1, wherein at least one of the drive member and the valve closure member is biased resiliently towards the drive train, compressing the drive train between the drive member and the valve closure member.

4. The valve assembly of claim 1, wherein the bearing devices include ball bearings.

5. The valve assembly of claim 1, wherein the valve assembly is a subsea valve assembly deployed in a well selected from the group consisting of: (a) an oil well, (b) a gas well, and (c) a water well.

6. The valve assembly of claim 1, wherein the valve closure member includes a ball valve adapted to rotate to open and close a flowpath in the well.

7. (canceled)

8. The valve assembly of claim 1, wherein the bore of the conduit is configured to receive at least one of (a) a string of tools deployed into the well, and (b) wireline deployed into the well.

9. The valve assembly of claim 1, wherein the valve closure member includes a shoulder member movable pivotally around the pivot axis of the valve closure member.

10. The valve assembly of claim 9, wherein the shoulder member includes a shoulder engaged by a selected one of the bearing devices in the drive train so as to transmit force between the selected bearing device and the shoulder, and wherein the shoulder member is connected to the valve closure member, wherein pivoting of the shoulder member around the pivot axis of the valve closure member rotates the valve closure member between open and closed configurations.

11. The valve assembly of claim 1, wherein the shoulder member extends from a flat surface of the valve closure member.

12. The valve assembly of claim 1, wherein first and second drive members drive the valve closure member in opposite rotational directions.

13. The valve assembly of claim 12, wherein the first and second drive members respectively rotate the valve closure member between corresponding open and closed configurations, wherein the conduit with the bore is in fluid communication with a fluid pathway through the valve closure member so as to (1) allow fluid passage through the valve closure member in an open configuration, and (2) resist fluid passage through the valve closure member in a closed configuration.

14. The valve assembly of claim 1, wherein the valve assembly further includes a clutch mechanism, the clutch mechanism disposed to shift between different clutch configurations so as to (1) move the drive member on its linear path, and (2) move the valve closure member.

15. The valve assembly of claim 14, wherein the clutch mechanism is disposed to shift between different clutch configurations without triggering a corresponding change in configuration of the valve closure member.

16. The valve assembly of claim 1, wherein the valve assembly is actuated between open and closed configurations by exposure to pressure changes.

17. The valve assembly of claim 1, wherein the valve assembly further includes:
at least one fluid chamber adapted for holding a pressure; and
a piston sealed within each fluid chamber;
wherein, for each fluid chamber, the valve assembly is disposed to be actuated between different configurations by a fluid pressure differential across the corresponding piston.

18. The valve assembly of claim 17, wherein the at least one fluid chamber includes first and second fluid chambers each having a corresponding piston, wherein said first chamber is pre-charged with pressurized fluid to a first pressure, and wherein said second chamber is pre-charged with pressurized fluid to a second pressure lower than the first pressure, and wherein the first pressure is a minimum threshold pressure for actuating the valve assembly between different configurations.

19. The valve assembly of claim 17, wherein at least one piston is exposed to an outer surface of the valve assembly.

20. The valve assembly of claim 1, wherein the valve assembly further includes a housing having a side wall, wherein the drive member and drive train are disposed in the side wall so as to be isolated from the bore of the valve assembly.

21. The valve assembly of claim 1, wherein the valve assembly further includes a locking mechanism, the locking mechanism disposed to lock the valve assembly against changes in configuration.

22. (canceled)

23. (canceled)

24. (canceled)

25. (canceled)

26. (canceled)

27. (canceled)

28. (canceled)

29. (canceled)

30. (canceled)

31. A ball valve for opening or closing a bore in a fluid pathway in a selected one of (a) an oil well, (b) a gas well, or (c) a water well, the ball valve comprising:
a drive member movable on a linear path;
a valve closure member movable on a rotational path around a pivot axis;
a drive train transmitting force between the drive member and the valve closure member;
wherein the drive train includes a plurality of bearing devices, wherein each bearing device is constrained in a bearing track.

32. An actuator assembly for actuating a mechanism in a selected one of (a) an oil well, (b) a gas well, or (c) a water well, the actuator comprising:
a drive member movable on a linear path;
a rotary member movable on a rotational path around a pivot axis;
a drive train transmitting force between the drive member and the rotary member;
wherein the drive train includes a plurality of bearing devices, wherein each bearing device is constrained in a bearing track.
